(19) United States
(12) Patent Application Publication
(10) Pub. No.: US 2016/0220932 A1
(43) Pub. Date: Aug. 4, 2016

(54) FILTER AID AND FILTER LAYER

(71) Applicants: KRONES AG, Neutraubling (DE); KELHEIM FIBRES GMBH, Kelheim (DE)

(72) Inventors: Bernd Probst, Kelheim (DE); Walter Rogenstein, Bad Abbach (DE); Roland Scholz, Regensburg (DE); Daniela Bauer, Regensburg (DE); Thomas Kandler, Teugn (DE); Jörg Zacharias, Koefering (DE); Michael Auburger, Bruck (DE); Ralf Schneid, Freising (DE)

(21) Appl. No.: 15/021,302

(22) PCT Filed: Sep. 8, 2014
(86) PCT No.: PCT/EP2014/069111

§ 371 Date: Mar. 11, 2016

(30) Foreign Application Priority Data
Sep. 13, 2013 (DE) 10 2013 218 412.3

(51) Int. Cl. B01D 37/02; B01D 39/04; C12H 1/07

(52) U.S. Cl. CPC B01D 37/02; C12H 1/063; B01D 39/04

(57) ABSTRACT

A filter aid for a pre-coat filter, the filter agent comprising regenerated cellulose fibers, and a method for filtering or stabilizing an unfiltered product, including: provision of a pre-coat filter; pre-coating of a filter means of the pre-coat filter with regenerated cellulose fibers acting as a filter aid, in order to form a filter layer and passing of the unfiltered product through the filter layer that has been formed. Also, a filter layer including regenerated cellulose fibers for a plate press, plate-and-frame filter or plate filter for filtering a beverage.

### CROSS-REFERENCE TO RELATED APPLICATION

The present application is the United States national phase of International Patent Application No. PCT/EP2014/069111, filed Sep. 8, 2014, which application claims to German Application No. 10 2013 218 412.3, filed Sep. 13, 2013. The priority application is hereby incorporated by reference.

### FIELD OF THE DISCLOSURE

The present disclosure relates to a filter aid for pre-coat filters for the filtration of fluids, in particular beer. In addition, the disclosure relates to a filter layer.

### BACKGROUND OF THE DISCLOSURE

At the end of the maturing process, beer contains a variety of yeast and turbid particles, which are in particular for the purpose of consumer expectations (e.g. polished shine) and stabilization to be removed by filtration. For this purpose, the turbid beer, i.e. the unfiltered product, is by way of a filter device separated into a clean filtrate and a remaining filter residue (filter cake).

For example, pre-coat candle filters are used for the filtration of the turbid beer. Located in the filter tank of the pre-coat candle filter are filter candles which are, for example, attached suspended from a top plate or on a register. The filter candles generally have a filter body which can comprise, for example, a wound wire, where gaps between the wire turns serve as passages for the medium to be filtered. The wound wire is either self-supporting or held by a support associated with the wound wire. Filter aids are for filtration added to the beer. The filter aids are pre-coated at the start of the filtration operation on the outer surface of the filter body, so that a pre-coat layer is formed composed of a primary pre-coat layer and a safety layer which serves as a filter layer. During the filtration process, filter aid is regularly added to the beer to be filtered, this is referred to as continuous dosage. The major filter aid for the filtration of beer is calcined diatomite. However, calcined diatomite contains cristobalite. Inhalation of cristobalite can lead to pneumoconiosis. Cristobalite is in dust form also classified as being a carcinogenic substance. Diatomite dust must therefore be handled while observing strict and complex safety measures. In addition, diatomite is a relatively expensive filter aid, mainly due to the disposal, since the diatomite sludge obtained during the filtration may no longer be disposed of in an untreated manner—must in future possibly even be disposed of as hazardous waste.

Other substances as filter aids are mentioned in EP 1 243 302 B1 There have in particular been trials to use cellulose as a filter aid. DE 10 2004 062 617 A1 describes a commercial natural cellulose fiber that was used for filtration. However, the form of the cellulose used is a fiber left in its natural state and merely cleaned. The natural cellulose fibers are usually flat hollow fibers. When dry, these fibers are of a ribbon shape and partly twisted. Typical fibers of this type are, for example, also cotton fibers for the textile sector, or pulp fibers for paper production. However, the fining effect and the economic efficiency of this cellulose were not satisfactory. It was in addition not possible to achieve sufficient adaptability to different unfiltered products, in particular to different beer qualities. Furthermore, trials were conducted with Crosspure, a regenerable combination of filter aids and tanning stabilizing agents. In addition to very high set-up times and poor adaptability to the unfiltered product, also the high costs are disadvantageous.

The use of cellulose fibrils as filter aids having an aspect ratio (ratio of length to diameter) of at least 200 is inter alia known from DE 196 28 324. Fibrils can be obtained by breaking down cellulose fibers and they differ from cellulose fibers, inter alia, by their smaller diameter.

### SUMMARY OF THE DISCLOSURE

The present disclosure is therefore based on one aspect of providing a filter aid as an alternative to diatomite that has similarly good filtration properties but which is inexpensive to produce and without any health concerns.

The above aspect is satisfied by a filter aid comprising regenerated cellulose fibers (“zellulosische Regeneratfasern”). These are fibers that are made from naturally occurring cellulose or pulp by dissolving, spinning the solution and precipitating the spun fibers, and therefore differ substantially from the natural cellulose fibers described above. As used herein, the term “regenerated cellulose fibers” can refer to fibers that are composed entirely of cellulose except for impurities, for example, small amounts of hemicellulose and residual lignin. The regenerated cellulose fibers can contain more that 98%, in particular more than 99% and more than 99.5% cellulose, in particular α-cellulose. They differ from naturally occurring cellulose and pulps in particular by their crystalline structure, and naturally by the shape defined by the manufacturing process, in particular their defined length and their cross-sectional shape.

The regenerated cellulose fibers differ from the cellulose fibrils mentioned in DE 196 28 324 already due to their larger diameter and thereby also due to a significantly smaller ratio of length to diameter.

On the basis of clearly defineable conditions of the respective manufacturing process, the properties of regenerated cellulose fibers, such as thickness (titer), length or cross-sectional shape, can be selectively adjusted.

The regenerated cellulose fibers can in particular be viscose fibers, modal fibers or Lyocell fibers. The fibers can have a titer range from 0.1 to 30 dtex, for example, 0.1 or 3 dtex to 20 dtex, or 0.1 or 5 dtex to 17 dtex, or 0.1 or 0.5 dtex to 2 dtex.

The length of the regenerated cellulose fibers can be less than 20 mm, in particular less than 1 mm, in particular 0.01 mm to 0.9 mm, particularly preferably 0.1 mm to 0.3 mm.

The regenerated fibers of this length are obtained in particular by cutting. Alternatively, the fibers can also be ground.

In experiments performed for determining the porosity of a filter cake obtained by pre-coating regenerated fibers, fibers having a high titer and a short length, in particular having a length of 0.1 mm to 0.3 mm, in particular 0.1 mm and a titer of 5 dtex to 17 dtex, in particular 17 dtex, have delivered good results.

Regenerated cellulose fibers can have different cross-sections that are definable, for example, by the geometry of the spinning nozzle hole. Regenerated fibers can for instance have substantially circular cross-sections, flat cross-sections or multi-legged (e.g. “Y-shaped”) cross-sections. In sedimentation trails, the regenerated cellulose fibers with substantially circular cross-sections have shown to be advantageous over fibers with a flat or multi-legged cross-section.

The regenerated cellulose fibers can be given in the form of a mixture of two or more types of fibers which differ from one another by one or more of the parameters titer, length, cross-sectional shape, zeta potential and hydrophilicity.

For example, two otherwise identical fibers with the same cut length but different titers can be mixed together. Furthermore, fibers with different cross-sectional shapes (round, multi-legged etc.) can be mixed.

Regenerated cellulose fibers are being already hydrophilic pre se can be designed to be even more hydrophilic, for example, by chemical modification (e.g. by incorporation of carboxymethyl cellulose). Conversely, regenerated cellulose fibers can also be hydrophobically modified by respective modification (e.g. incorporation of hydrophobic substances).

According to one embodiment, viscose fibers are used as regenerated fibers, i.e. fibers produced according to the viscose method.

A filter aid is therefore in particular provided comprising regenerated fibers which are composed exclusively of viscose. Here and hereinafter, the term filter aid comprises both auxiliary agents for filtration as well as auxiliary agents for stabilization of a fluid. The filter aid can comprise further materials, for example, further fibers or be composed entirely of the regenerated cellulose fibers. The proportion of the regenerated cellulose fibers in the filter aid can be from 1% to 100%, in particular 20% to 100% and further in particular 50% to 100%. For filtration, a filter cake with a secondary structure of the fibers is formed from the pre-coated fibers

For example, the regenerated cellulose fibers can be used as a filter aid for pre-coat candle filters, pre-coat sheet filters, pre-coat plate press filters (for example, consisting of plate-and-frames and/or plates) for the filtration or stabilization of beverages, for example, for beer filtration or stabilization. The plates, sheets, candles or frames can there be arranged horizontally or vertically. In addition, it is conceivable that the regenerated cellulose fibers are incorporated directly into the layers or plates, in this case, the filter body is the filter layer, mentioning a plate press filter as an example for this. Apart from beverages, which can in addition to beer also be, for example, juices, tea, spirits or wine, the filtration of (edible) oils is also possible.

When speaking of a pre-coat filter, the filter layer refers to the pre-coat layer, i.e. the layer which is formed by the filter aid on the filter body.

Experiments have shown that efficient beer filtration is possible by using regenerated cellulose fibers, in particular viscose fibers, where the regenerated cellulose fibers can be employed in particular instead of diatomite for the filtration by use of conventional pre-coat filters. The use of cellulose is inexpensive and poses no risks to health. In addition, regenerated cellulose fibers have the advantage that they can be selectively adapted in terms of their shape, their cross-section and their length, and a high degree of adaptability to the respective beer to be filtered or the type of beer can be provided in addition to a high degree of fining. Annual fluctuations in quality of raw materials and the beer produced therefrom can thereby be easily compensated. The filter cake can be safely disposed of as household waste.

However, it is also possible in principle that the filter aid comprises not only regenerated cellulose fiber, but for example also contains a certain amount of diatomite.

A method is also provided for the filtration or stabilization of a fluid (i.e. an unfiltered product, e.g. a turbid, meaning unfiltered beer) comprising the steps of providing a pre-coat filter, pre-coating of a filter device (a filter body) of the pre-coat filter with regenerated cellulose fibers acting as a filter aid, in order to form a filter layer and passing of the unfiltered product through the filter layer that has been formed. The fluid can be turbid or unstabilized beer, wine or fruit juice (e.g. apple juice). The regenerated cellulose fibers can be configured as described above. Filtration of the fluid (e.g. turbid beer) can comprise adding regenerated cellulose fibers to the fluid. This dosage can be adjusted during the process of filtration.

Furthermore, filter layers or filter plates are provided with regenerated cellulose fibers for use in candle, module, plate press, plate-and-frame or plate filters which are no pre-coat filters, for the filtration of beverages, such as beer. The regenerated cellulose fibers can be configured as described above. The filter layer can be configured in the form of a pad, a candle, a plate or a cake with a jacket permeable to fluid in which the regenerated cellulose fibers are located. The regenerated cellulose fibers can in particular be arranged loosely in the pad or in plates, i.e. not be connected to each other by a binding agent.

A respective candle, module, plate press, plate-and-frame or plate filter is likewise provided with a plurality of these filter layers or plates, respectively. It can be provided that at least two of the filter layers have regenerated cellulose fibers that differ (for example, in type, shape, size, etc.). For example, a first filter layer can comprise hydrophobic regenerated cellulose fibers and a second filter layer adjacent to the first filter layer hydrophilic ones. In particular, filter layers comprising hydrophilic and hydrophobic regenerated cellulose fibers can be alternately provided. In a further development, a number (one or more) of first filter layers with regenerated cellulose fibers is formed for filtering out particles of a first average size, while a number (one or more) of second filter layers with regenerated cellulose fibers is formed for filtering out particles of a second average size that differs from the first average size. The combination of hydrophilic and hydrophobic layers is also intended to enable adjustment of the flow rate through the layers in order to be able to obtain optimal filtration results.

### BRIEF DESCRIPTION OF THE DRAWINGS

Embodiments of a disclosure use of regenerated cellulose fibers as filter aids in a pre-coat filter or as filter layers in a plate press filter are described below with reference to the drawings. The embodiments described are to be considered in all aspects as being only illustrative and not restrictive and various combinations of the features specified are comprised by the disclosure.

FIG. 1 shows a pre-coat filter in which the filter aid according to the disclosure can be used.

FIG. 2 shows a horizontal filter for filter layers of regenerated cellulose fibers.

### DETAILED DESCRIPTION

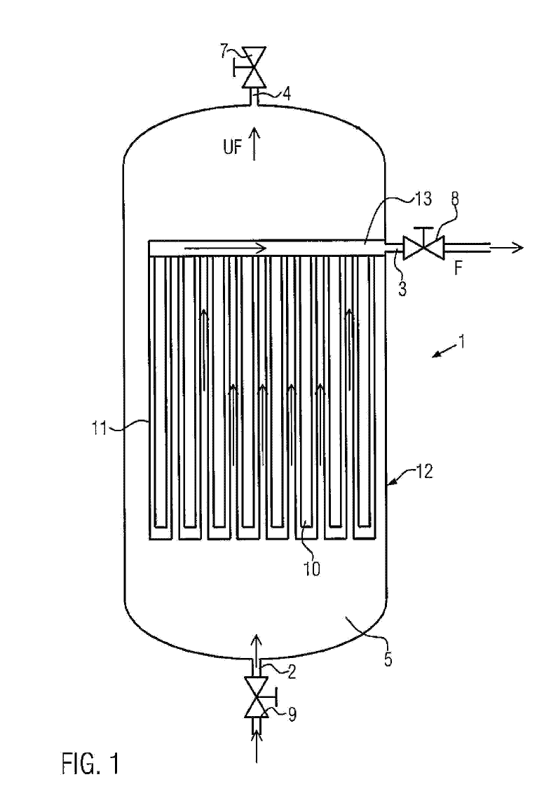

A pre-coat filter 1 is shown in FIG. 1 in which the filter aid according to the disclosure with regenerated cellulose fibers can be used. Pre-coat filter 1 comprises a filter tank 12 comprising a space 5 for the unfiltered product. Filter candles 10 are as a filter medium arranged vertically in space 5 for the unfiltered product. Filter candles 10 having a substantially hollow cylinder shape comprise a filter element—not shown in more detail—having a hollow cylinder shape and respective fluid passages. The filter element can consist, for example, of a helically wound wire.

Filter tank 12 further comprises an inlet 2 for the unfiltered product, where the amount of unfiltered product can be adjusted, for example, by use of a control valve 9. The filter tank further comprises an outlet 4 for a portion of the unfiltered product from space 5 for the unfiltered product. Outlet 4 for the unfiltered product can be regulated by use of a respective device, presently e.g. control valve 7. Outlet 4 can in particular by use of a bypass line—not shown—be in communication with inlet 2 for the unfiltered product.

Filter candles 10 open into a register 13 via which the filtrate can be drained from filter candles 10. The filter element outlets of filter candles 10 are by way of pipe systems combined and drained separately. Register 13 therefore provides outlet 3 for the filtrate, where the flow rate can be adjusted by way of a device, such as control valve 8.

During operation of pre-coat filter 1, the unfiltered product is via inlet 2 introduced into space 5 for the unfiltered product, where filter aid with regenerated cellulose fibers, for example, viscose fibers is added to the unfiltered product. Pre-coat layer 11 at the surface of filter candles 10 is created prior to the filtration and is permanently maintained during the filtration by the addition of filter aid. Prior to the actual filtration or stabilization, the basic pre-coating can also take place in particular with degassed water or filtered beer for establishing a pre-coat layer. Due to the fact that a defined flow of unfiltered product is by use of outlet 4 generated in the direction of outlet 4, as shown by the arrows, even pre-coating of the filter aid with regenerated cellulose fibers is achieved. Several outlets can of course be present distributed over the circumference and then lead, for example, to a common manifold. The evenness of the flow is thereby further improved.

The unfiltered product not being drained via outlet 4 passes through the fluid passages of filter candles 10 into the filter candles and is filtered It then passes through filter candles 10 upwardly into a register 13, from where it can then drain via outlet 3. As an alternative to a register, supply into a filtrate space would also be conceivable, from where it is then supplied to outlet 3.

Regenerated cellulose fibers are according to the disclosure used as a filter aid for pre-coat filters. These regenerated cellulose fibers are with the exception of minor impurities composed of cellulose. The regenerated cellulose fibers can with the exception of impurities be composed of α-, β-, and γ-cellulose. They can there substantially or solely with the exception of impurities be composed of α-cellulose. The regenerated cellulose fibers are to be distinguished from natural cellulose fibers and cellulose fibers. The latter typically have cellulose as a major component, but can not be equated with regenerated cellulose fibers. Regenerated cellulose fibers differ from naturally occurring cellulose and pulps in particular by their crystalline structure, and naturally by the shape defined by the manufacturing process, in particular their defined length and their cross-sectional shape.

The regenerated cellulose fibers can be in particular differentiated into viscose fibers, modal fibers and Lyocell fibers and can be provided having different diameters, lengths, cross-sectional shapes and surface structures. The viscose fibers can be spun by known viscose processes. The modal fibers have a higher strength as compared to viscose fibers. Lyocell fibers are obtained by a spinning process in which cellulose is dissolved in N-methylmorpholine-N-oxide (NMMO).

The particular distinction between viscose fibers and natural cellulose fibers can be described as follows: viscose fibers, like natural cellulose fibers, are made 100% of cellulose. Viscose fibers are made of special pulps (i.e., pulp fibers). For this purpose, the cellulose of the pulp is by a chemical process (xanthogenate method) converted into a form soluble in caustic soda. The dissolved cellulose is finally spun out through defined nozzles (spinning holes or channels) into a precipitation bath. An endless cellulose yarn is created for every nozzle hole which can subsequently be stretched, washed, post-treated, cut and dried, if necessary. The following control options for the fiber properties are thereby given directly in the spinning process:

(1) Defined adjustment of the fiber diameter.

(2) Defined adjustment of the fiber length.

(3) Defined adjustment of various cross-sectional shapes.

(4) Defined adjustment of the surface structure.

(5) Supplying additives to the textile material, so that additives can be incorporated homogeneously over the cross-section of the fiber.

These five control options are not possible for natural cellulose fibers. Viscose fibers made of the natural macromolecule (“polymer”) cellulose can therefore be customized and functionalized in an extremely diverse manner.

Examples for this are the following types of viscose fibers from the company Kelheim Fibers GmbH:
Viscose fiber—Danufil (fiber with a round cross-section)
Viscose fiber—Viloft (fiber with a flat cross-section),
Viscose fiber—Galaxy (fiber with a trilobal cross-section), see EP 0 301 874,
Viscose fiber—Bellini (flax fiber with a smooth surface),
Viscose fiber—Bramante (hollow fiber), see WO 2011/012424,
Viscose fiber—Poseidon (functionalized round fiber with ion exchange properties),
Viscose fiber—Umberto (fiber with a letter-shaped cross-section), see WO 2014/037191,
Viscose fiber—Olea (fiber with hydrophobic properties), see WO 2014/090665,
Viscose fiber—Leonardo (fiber with an extremely flat cross-section and smooth surface), see WO 2013/079305,
Viscose fiber—Verdi (fiber with a round cross-section, anionically modified by incorporation of carboxymethyl cellulose),
Viscose fiber—Deep Dye (cationically modified fiber).

Fibrils obtained from cellulose fibers differ from regenerated cellulose fibers already in their greater thickness and the lower aspect ratio arising therefrom.

Filter aids with regenerated cellulose fibers can also be used for pre-coat filters in which the pre-coat layers are formed on mesh-shaped filter bases. A pre-coat filter can comprise a plurality of mesh bases as filter devices, the mesh openings of which can be of different dimensions. Some mesh bases can be used for coarser filtration and other filter bases for finer filtration by use of the filter aid. The filtering effect can thereby be adjusted more individually and better adapted to the respective unfiltered product (see filtration of water through layers of soil).

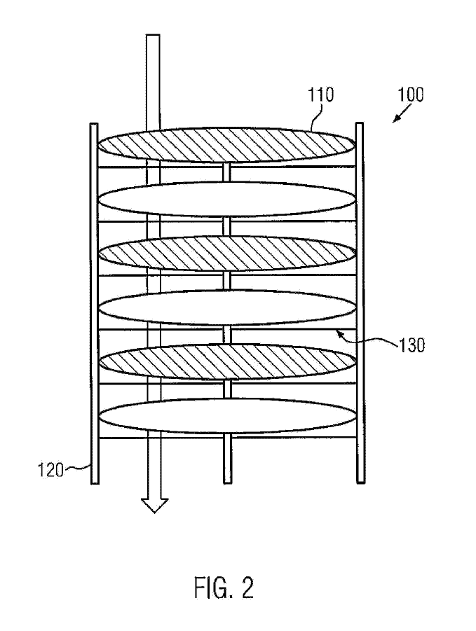

A plate press filter 100 with filter layers 110, 110′ with regenerated cellulose fibers is shown in FIG. 2. Plate press filter 100 does not operate according to the pre-coat principle. It comprises a filter frame 120 and supports 130 for filter layers 110, 110′. An unfiltered product, such as beer, passes through plate press filter 100, as indicated by the arrow. In the example shown in FIG. 2, filter layers 110, 110′ are configured in the form of filter pads. The filter pads contain the regenerated cellulose fibers without a binding agent in a jacket that is permeable to fluid. In the example shown, pads are alternately shown with different regenerated cellulose fibers, for example, various viscose fibers. Hydrophobic 110 and hydrophilic 110′ filter layers can thus be alternately provided. Alternatively, one could also use filter plates. It is also possible to reverse the flow of an unfiltered product, meaning to pass it from the bottom upwardly.

The regenerated cellulose fibers can be provided in dust-like or granular form. They can also be stored in an already swollen state, so that they can be passed from a storage tank directly into the pre-coating area when the filter is operated according to the pre-coat principle. In an alternative example, the filter layers are provided in the form of pressed filter plates.

Filter layers, which are applied for example in the form of pads on filter plates, can be replaced with fresh filter layers when used up and disposed by way of an automatic exchange system (handling robot). This eliminates manual cleaning of bases and faster exchange times can without the use of personnel be achieved that are faster than compared to conventional filter assemblies with loose filter aid.

What is claimed is:

1. A filter aid for a pre-coat filter, comprising regenerated cellulose fibers.

2. The filter aid according to claim 1, and the regenerated cellulose fibers have a titer of 0.1 to 30 dtex.

3. The filter aid according to claim 1, and the length of the regenerated cellulose fibers is less than 1 mm.

4. The filter aid according to claim 1, and the regenerated cellulose fibers are in the form of a mixture of two or more types of fibers which differ from one another by one or more of the parameters titer, length, cross-sectional shape, zeta potential and hydrophilicity.

5. The filter aid according to claim 1, and the regenerated cellulose fibers comprise one of viscose fibers, modal fibers, Lyocell fibers, and a combination thereof.

6. The filter aid according to claim 1, and the proportion of the regenerated cellulose fibers is 1% to 100%.

7. Use of a filter aid according to claim 1 for a pre-coat candle filter, a pre-coat sheet filter, or a pre-coat plate press filter, comprising at least one of frames or plates for the filtration or stabilization of beverages.

8. A method for filtering or stabilizing a fluid, comprising
providing a pre-coat filter;
pre-coating a filter device of the pre-coat filter with regenerated cellulose fibers acting as a filter aid, in order to form a pre-coat filter layer; and
passing a fluid through said pre-coat filter layer that has been formed.

9. The method according to claim 8, and the regenerated cellulose fibers are added to the fluid.

10. The method according to claim 8, and the regenerated cellulose fibers are one of viscose fibers, modal fibers, Lyocell fibers, and combinations thereof.

11. A filter layer for filtering fluids, comprising regenerated cellulose fibers.

12. The filter layer according to claim 11, and the regenerated cellulose fibers comprise one of viscose fibers, modal fibers, Lyocell fibers, and combinations thereof.

13. The filter layer according to claim 11, and the filter layer is configured in the form of a pad with a jacket permeable to fluid in which the regenerated cellulose fibers are located.

14. A candle, module, plate press, plate-and-frame or plate filter with a plurality of filter layers formed according to claim 11.

15. A candle, module, press plate, plate-and-frame or plate filter formal according to claim 14, in which at least two of the plurality of filter layers comprise different regenerated cellulose fibers, and one of the at least two filter layers comprises hydrophobic regenerated cellulose fibers.

16. The filter aid according to claim 3, and the length of the regenerated cellulose fibers is in the range from 0.01 mm to 0.9 mm.

17. The filter aid according to claim 3, and the length of the regenerated cellulose fibers is in the range from 0.1 mm to 0.3 mm.

18. The filter aid according to claim 6, and the proportion of the regenerated cellulose fibers is 20% to 100%.

19. The filter aid according to claim 6, and the proportion of the regenerated cellulose fibers is 50% to 100%.

20. The use of a filter aid according to claim 7, wherein the beverages comprise beer.

21. The filter layer according to claim 11, the filter layer incorporated into one of a plate press, a plate-and-frame, a plate or a candle filter.

22. The candle, module, press plate, plate-and-frame, a plate filter according to claim 15, and the other of the at least two filter layers comprises hydrophilic regenerated cellulose fibers.
